(19) United States
(12) Patent Application Publication
(10) Pub. No.: US 2024/0093692 A1
(43) Pub. Date: Mar. 21, 2024

(54) BEARING WEAR MONITORING

(71) Applicant: Edwards Limited, Burgess Hill, Sussex (GB)

(72) Inventors: James Alexander Haylock, Burgess Hill, Sussex (GB); Christopher Miles, Burgess Hill, Sussex (GB); Alexander James Patey, Burgess Hill, Sussex (GB)

(21) Appl. No.: 18/256,551

(22) PCT Filed: Dec. 14, 2021
(86) PCT No.: PCT/GB2021/053283

§ 371 Date: Jun. 8, 2023

(30) Foreign Application Priority Data
Dec. 16, 2020 (GB) 2019847.9

(51) Int. Cl. F04D 27/00; F04D 29/056; G01M 13/04

(52) U.S. Cl. CPC F04D 27/001; F04D 29/056; G01M 13/04

(57) ABSTRACT

A monitoring apparatus includes: input reception circuitry configured to receive a signal indicative of a characteristic of rotating assembly rotation; and bearing wear monitoring circuitry configured to analyze the signal characteristic of rotating assembly rotation. The bearing wear monitoring circuitry is also configured to identify one or more signal features indicative of bearing wear. Bearing wear produces variation in rolling friction of the bearing and therefore is one cause of variation in shaft torque. Aspects recognise that variations in shaft torque can be indirectly monitored, measured and/or determined by appropriate measurement or monitoring of operational characteristics of a pump motor and that it may be possible to distinguish variations in shaft torque which can be attributed to bearing wear from those variations in shaft torque caused by one or more other factors.

### CROSS-REFERENCE OF RELATED APPLICATION

This application is a Section 371 National Stage Application of International Application No. PCT/GB2021/053283, filed Dec. 14, 2021, and published as WO 2022/129888A1 on Jun. 23, 2022, the content of which is hereby incorporated by reference in its entirety and which claims priority of British Application No. 2019847.9, filed Dec. 16, 2020.

### FIELD

The field of the invention relates to bearing wear monitoring apparatus; a bearing wear monitoring method and a pump apparatus comprising a bearing wear monitoring apparatus. More particularly, but not exclusively, the present disclosure relates to bearing wear monitoring apparatus for monitoring operation of a vacuum pump, and to a vacuum pump apparatus comprising a bearing wear monitoring apparatus.

### BACKGROUND

A pump system will typically comprise: a pump including a stator and a rotating assembly part; an inverter and a pump controller. Pumps of interest may include a vacuum pump, such as a turbo pump, or a multi-stage positive displacement pump, for pumping gas from a semiconductor tool or the like. However, it will be appreciated that the issues associated with operation of a pump are not limited to a particular type of pump mechanism. As described above, a pump typically comprises: an electric motor having a stator and a rotating assembly. The rotating assembly may comprise a motor rotor, a shaft and a pump impeller. The rotor will typically be mounted such that bearings ensure smooth rotation of the shaft associated with the rotor. Bearing wear, for example, from spalling of associated raceways or damage to a bearing cage, can cause an increase in rolling frictional forces associated with the bearing, and may consequently impact upon operation of the pump and pump system.

At least in certain embodiments, the present invention seeks to overcome or ameliorate at least some of the limitations associated with operation of a pump experiencing bearing wear.

The discussion above is merely provided for general background information and is not intended to be used as an aid in determining the scope of the claimed subject matter. The claimed subject matter is not limited to implementations that solve any or all disadvantages noted in the background.

### SUMMARY

A first aspect provides bearing wear monitoring apparatus configured to monitor bearings of a vacuum pump having an electric motor comprising a rotating assembly, the monitoring apparatus comprising: input reception circuitry configured to receive a signal indicative of a characteristic of rotating assembly rotation, the signal indicative of a characteristic of rotating assembly rotation comprising at least one of an indication of rotational speed, and an indication of motor power; and bearing wear monitoring circuitry configured to analyse the signal characteristic of rotating assembly rotation over time and identify one or more signal feature indicative of bearing wear.

The first aspect recognises that typically a pump motor is configured to maintain a target rotation speed. The rotation speed of rotating components forming a rotating assembly in a pump motor arrangement will be affected by torque on a motor rotor shaft. As a result, reaching the target speed will depend upon shaft torque. Bearing wear produces variation in rolling friction of the bearing and therefore is one cause of variation in shaft torque. Other factors may also cause variation in shaft torque, for example, in relation to operation of a motor in a vacuum pump system, potential causes include: changing gas load, thermal effects, back pressure changes, changes in modes of operation of a pump motor and/or varying pump load.

The first aspect particularly recognises that variations in shaft torque can be indirectly monitored, measured and/or determined by appropriate measurement or monitoring of operational characteristics of a pump motor. The first aspect further recognises that it may be possible to distinguish variations in shaft torque which can be attributed to bearing wear from those variations in shaft torque caused by one or more other factors. These variations in shaft torque may cause sudden deceleration of the rotation and/or an increase in motor power required to maintain rotation.

It will be appreciated that operational characteristics of a pump motor which could help to recognise variation in shaft torque typically relate to an indirect indication of aspects of the rotating assembly motion. Varying bearing rolling friction, as might be associated with bearing wear, will cause fluctuations in the rotational movement of a shaft or motor rotor, which are then translated to operation of the pump. The rotational fluctuations relate to changes in the operation of, for example, the motor driving a shaft or pump, as it is adjusted to compensate for “sticking” caused by bearing wear.

The first aspect recognises that appropriate analysis of at least one of rotational speed and motor power over time can reveal features which may be characteristic of bearing wear.

According to some embodiments, the signal feature is predefined and represents a known bearing wear condition. Accordingly, simple detection of a feature in a signal may be indicative of bearing wear.

According to some embodiments, the apparatus may include a user alarm configured to be triggered on identification of the one or more signal feature indicative of bearing wear. That alarm condition may be relayed to a user or to a pump control unit. The alarm may comprise a visual or audible alarm. The alarm may trigger further action, for example, safe pump shutdown.

According to some embodiments, the signal indicative of a characteristic of rotating assembly rotation comprises: the indication of rotational speed.

Accordingly, the rotational speed of a shaft or pump being driven by a motor shaft may provide a mechanism to identify the frictional or sticking impact that bearing wear may have upon operation of a pump.

According to some embodiments, the signal feature indicative of bearing wear comprises: rate of deceleration exceeding a predetermined threshold. Accordingly, the sticking associated with bearing or bearing cage wear may cause unexpected deceleration of the pump impeller or rotor or shaft.

According to some embodiments, the signal feature indicative of bearing wear comprises: identification of increased deceleration compared to historic deceleration events. According to some embodiments, the signal feature indicative of bearing wear comprises: identification of increased deceleration compared to known or scheduled deceleration events. According to some embodiments, the signal feature indicative of bearing wear comprises: identification of increased deceleration compared a predetermined deceleration threshold.

According to some embodiments, the signal indicative of a characteristic of rotating assembly rotation comprises: the indication of motor power. An increased power demand can be indicative of bearing wear, as power is increased to overcome sticking and friction.

According to some embodiments, the signal feature indicative of bearing wear comprises: motor power being at a maximum for a predetermined time period.

According to some embodiments, the input reception circuitry is configured to receive a signal indicative of an operational characteristic of the vacuum pump, and the signal feature indicative of bearing wear comprises: motor power being at a maximum despite the operational characteristic signal indicating that the vacuum pump is unlikely to require maximum motor power. Increased, or maximum motor power can be expected at various points of usual pump operation. In the case of a vacuum pump, for example, maximum power may be required on initial start up of the pump, and in the case of increased gas load. By providing the bearing wear apparatus with an indication of the operational conditions of the pump, it is possible to prevent false triggering of a bearing wear alert.

According to some embodiments, the signal indicative of a characteristic of rotating assembly rotation comprises both an indication of rotational speed and an indication of motor power.

Although either one of rotational speed or motor power when measured over a time period may provide an indication of bearing wear, in some cases both are used, allowing for a more accurate fault diagnosis.

According to some embodiments, a bearing wear fault diagnostic is associated with the identification of the one or more signal feature indicative of bearing wear. Accordingly, the nature of a bearing wear fault may be identifiable from the signal or signals being analysed.

According to some embodiments the bearing wear monitoring apparatus is responsive to determining that the rate of deceleration exceeds the predetermined threshold to monitor power during a time period following said detected deceleration, the bearing wear fault diagnostic being responsive to an indication that said motor power monitored during said time period has exceeded a predetermined threshold to indicate bearing wear.

In some embodiments, the bearing wear monitoring apparatus may be responsive to detecting the rate of deceleration exceeding a threshold to monitor power consumed. As noted previously both deceleration and power are both indicative of bearing wear and deceleration is generally seen before an increase in power. Thus, monitoring power following a sudden deceleration may provide further evidence of bearing wear and enable a more reliable fault diagnosis.

A second aspect provides a vacuum pump apparatus comprising a bearing wear monitoring apparatus according to the first aspect.

A third aspect provides a method of monitoring wear of bearings of a vacuum pump having an electric motor comprising a rotating assembly, the method comprising:
receiving a signal indicative of a characteristic of rotating assembly rotation comprising at least one of an indication of rotational speed, and an indication of motor power; and
analysing the signal characteristic of rotating assembly rotation over time to identify one or more signal feature indicative of bearing wear.

In some embodiments, the signal feature is predefined and represents a known bearing wear condition.

In some embodiments, the method comprises triggering a user alarm on identification of the one or more signal feature indicative of bearing wear.

In some embodiments, the signal feature indicative of bearing wear comprises: rate of deceleration exceeding a predetermined threshold.

In some embodiments, the method comprises: identifying increased deceleration compared to historic deceleration events.

In some embodiments, the signal indicative of a characteristic of rotating assembly rotation comprises: an indication of motor power, and the method comprises analysing motor power over time to identify the one or more signal feature indicative of bearing wear.

In some embodiments, the signal feature indicative of bearing wear comprises: motor power being at a maximum for a predetermined time period.

In some embodiments, the method comprises receiving a signal indicative of an operational characteristic of the vacuum pump, and the signal feature indicative of bearing wear comprises: motor power being at a maximum despite the operational characteristic signal indicating that the vacuum pump is unlikely to require maximum motor power.

In some embodiments, the signal indicative of a characteristic of rotating assembly rotation comprises an indication of variation of motor phase current over time, and the method comprises transforming the time-based signal into a frequency-based signal; and analysing the frequency-based signal to identify the one or more signal feature indicative of bearing wear.

In some embodiments the signal indicative of a characteristic of rotating assembly rotation comprises both an indication of rotational speed and an indication of motor power.

In some embodiments, said signal features indicative of bearing wear comprising both rate of deceleration exceeding a predetermined threshold and motor power being at a maximum for a predetermined time period.

In some embodiments the method comprises in response to determining that the rate of deceleration exceeds the predetermined threshold monitoring power during a time period following said detected deceleration; and

In response to an indication that said motor power monitored during said time period has exceeded a predetermined threshold outputting an indicator indicating bearing wear.

In some embodiments, a bearing wear fault diagnostic is associated with the identification of the one or more signal feature indicative of bearing wear.

A fourth aspect provides a computer program comprising computer readable instructions which, when executed by a processor, are configured to cause a device to perform a method of the third aspect.

According to some related examples, the signal indicative of a characteristic of rotating assembly rotation comprises an indication of rotation period, and wherein the bearing wear monitoring circuitry is configured to analyse consecutive rotation periods to identify the one or more signal feature indicative of bearing wear. The rotation period may comprise time to complete one revolution or may, in some related examples, comprise time to complete a part revolution. Accordingly, if a shaft or rotor is getting stuck as a result of bearing wear, it would be expected to cause microfluctuations in rotational period. Analysis of adjacent consecutive rotation periods to determine time period fluctuation or variability can allow for identification of friction of the type typically caused by bearing wear.

According to some related examples, the rotation period comprises a time to complete a known angular rotation. That angular rotation may, for example, comprise: a single complete rotation, a partial rotation, or a number of consecutive rotations.

According to some related examples, the signal feature indicative of bearing wear comprises: variability in the rotation period exceeding a predetermined threshold.

According to some related examples, the signal feature indicative of bearing wear comprises: identification of increased variability on the rotation period compared to historic variation in the rotation period. Accordingly, historic analysis of a received signal in which no bearing wear is determined to be present may be stored in order that comparison may be made.

According to some related examples, the signal indicative of a characteristic of rotating assembly rotation comprises an indication of variation of motor phase current over time, and wherein the bearing wear monitoring circuitry is configured to transform the time-based signal into a frequency-based signal; and analyse the frequency-based signal to identify the one or more signal feature indicative of bearing wear. Since the pump operates to try and maintain a constant rotational speed, variation in current being supplied to the motor can provide an indication of variation in rotation of the rotor/shaft/pump forming the rotating assembly. Transforming the time based signal to a frequency based signal can allow for easier identification of features in the signal which may indicate bearing wear.

It will be appreciated that one operational characteristic of a pump motor which could help to recognise variation in shaft torque is that of current supplied to a pump motor, given a target of maintaining a rotational speed. Varying bearing rolling friction, as might be associated with bearing wear, will cause fluctuations in current, as it is adjusted to compensate for “sticking”.

Typically an indication of phase current is reported to a user or system controller via a pump ‘power’ reading which is refreshed & reported approx. every 1 to 2 seconds. This is effectively a ‘system power’ the time-averaged value obscures the microvariations in current which might be associated with fluctuations in shaft torque due to bearing wear and it makes it difficult to isolate increased friction resulting from effects of bearing wear from increased friction or torque due to other factors. As a result, pump ‘power’ is not a good indicator of bearing wear. By avoiding an averaged current signal and instead looking at microfluctuations, it is possible to identify features associated with bearing wear.

According to some related examples, the signal feature indicative of bearing wear comprises: at least one signal peak occurring at a predefined frequency or in a predefined frequency range in the frequency-based signal. Bearing wear may typically occur in a given frequency region.

According to some related examples, the signal feature indicative of bearing wear comprises: a signal peak passing a predefined threshold amplitude in the frequency-based signal. Accordingly, unexpectedly large peaks in the frequency-based signal, even at frequencies where a peak may usually be expected, may be indicative of bearing wear.

According to some related examples, the signal feature indicative of bearing wear comprises: identification of at least one new signal peak in the frequency-based signal compared to historic patterns in the frequency-based signal. Accordingly, emergence of a new frequency feature compared to historic frequency analysis of a signal may indicate bearing wear.

In some related examples, the signal indicative of a characteristic of rotating assembly rotation comprises an indication of rotation period, and the method comprises analysing consecutive rotation periods to identify the one or more signal feature indicative of bearing wear.

In some related examples, the method comprises identifying increased variability in the rotation period compared to historic variation in the rotation period.

In some related examples, the signal indicative of a characteristic of rotating assembly rotation comprises: an indication of rotational speed, and wherein the method comprises analysing rotational speed over time to identify the one or more signal feature indicative of bearing wear.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function. Where a feature is described as functional logic, it will be appreciated that the logic may be circuitry configured to perform the function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 illustrates schematically some main components of a vacuum pump apparatus incorporating a bearing wear monitoring device in accordance with various aspects and approaches described;

FIG. 2 is a schematic representation of a signal to be monitored by a bearing wear monitoring device such as that shown in FIG. 1;

FIG. 3 is a schematic representation of an alternative signal to be monitored by a bearing wear monitoring device such as that shown in FIG. 1; and

FIG. 4 is a schematic representation of a further signal to be monitored by a bearing wear monitoring device such as that shown in FIG. 1.

### DETAILED DESCRIPTION

Before discussing the embodiments in any more detail, first an overview will be provided.

A pump system will typically comprise: a pump including a stator and a rotating assembly part; an inverter and a pump controller. Pumps of interest may include a vacuum pump, such as a turbo pump or multi-stage positive displacement pump, for pumping gas from a semiconductor tool or the like. However, it will be appreciated that the issues associated with operation of a pump are not limited to a particular type of pump mechanism. As described above, a pump typically comprises: an electric motor having a stator and a rotor. The rotor will typically be mounted such that bearings ensure smooth rotation of a shaft associated with the rotor. The shaft may drive a pump impeller. The motor rotor, shaft and impeller may together comprise a rotating assembly. Bearing wear, for example, from spalling of associated raceways or damage to a bearing cage, can cause an increase in rolling frictional forces associated with the bearing, and may consequently impact upon operation of the pump and pump system. As a shaft is driven by a motor, the variations in rolling frictional forces may be measurable as microvariations in various operational characteristics of the motor. For example, friction changes due to bearing bear can cause microvariations in phase current and/or rotational speed. In order to detect or monitor such micro variations a measurement approach beyond a time averaged value typically supplied by a user interface or system controller is required.

A pump system in accordance with various arrangements will now be described. As described herein, a pump system 10 is configured to perform a self-diagnostic function in relation to bearing wear. FIG. 1 illustrates schematically some main components of a vacuum pump system 10 incorporating a bearing wear monitoring device in accordance with various aspects and approaches described.

The pump system 10 comprises a pump 20 driven by motor 25, a power source 30 and associated power supply electronics 35, and a control unit 40. The pump 20 in the described arrangement is a vacuum pump, such as a multi-stage positive displacement pump, for pumping gas from a semiconductor tool or the like. It will, however, be appreciated that the approaches described in relation to this arrangement are not limited to a particular type of pump mechanism.

The electric motor 30 comprises a stator and a rotor. The rotor is connected to a shaft which drives operation of pump 20. The rotor and shaft are associated with bearings, to allow smooth rotation of the shaft and transfer of the rotation to the pump. The control unit 40 is configured to be in communication with the pump power supply electronics 35 to control operation of the motor 25 driving the pump 20. The control unit also provides a human machine interface (HMI) to facilitate control of the pump 20. The control unit 40 comprises control circuitry and control software configured to process signals received from various components of the pump system 10 and one or more sensors associated with components of the pump system. The control unit is configured to process those input signals using control circuitry and to generate one or more outputs which can be communicated to one or more components of the pump system and control operation of the pump 20.

The pump system 10 shown in FIG. 1 includes bearing wear monitoring apparatus 50. Although shown as part of control unit 40, it will be appreciated that some implementations may provide separate bearing wear monitoring apparatus which may be configured to communicate with control unit 40. The bearing wear monitoring apparatus 50 includes bearing wear logic or circuitry and processing ability and is also configured to process signals received from various components of the pump system 10 and one or more sensors associated with components of the pump system. The bearing wear monitoring apparatus is configured to process those input signals using control circuitry and to generate one or more outputs which can be communicated to the control unit 40 and/or one or more components of the pump system and therefore directly, or indirectly, influence operation of the pump 20. The bearing wear monitoring apparatus may be associated with operation of bearing wear alarm 55. Bearing wear alarm 55 may be configured to provide a visual or audible alert to a system user in the event that bearing wear monitoring apparatus 50 detects possible bearing wear.

In the arrangement shown in FIG. 1, bearing wear monitoring apparatus is in communication with a rotor position measurement device 60. That rotor position measurement device 60 may be configured to measure or estimate rotational movement of the shaft driven by motor 25. Rotor position measurement device 60 may effect rotor position measurement using, for example, one or more hall switches, an encoder, or other position measurement or estimation device. An example signal 65 generated by rotor position measurement or estimation device 60 is shown, and takes the form of one or more pulses generated per revolution of the rotor or shaft. Bearing wear monitoring apparatus shown in FIG. 1 is also in communication with power supply electronics 35, and control unit 40.

Various approaches according to which bearing wear monitoring apparatus 50 may be configured to provide an assessment of bearing wear are discussed in detail. Some approaches described may be based upon taking multiple measurements per shaft revolution, some approaches may be based upon measurements taken over a longer time period, for example, a time period which encompasses several shaft revolutions.

Four general approaches are discussed in detail. It will be appreciated that the details of the general approaches may be combined as appropriate to provide hybrid approaches which may also provide mechanisms to assess bearing wear. Two of the described general approaches rely on very rapid measurements (micro- to milliseconds). Two of the described general approaches rely on longer-term measurements (seconds).

According to one general related approach, bearing wear logic may be configured to record or monitor motor phase current provided to the motor 25 by power source electronics 35 in order to try and provide a constant rotational speed. The bearing wear monitoring apparatus is configured to perform a transformation of the recorded or monitored motor phase current into the frequency domain. The motor phase current may be measured or monitored for each shaft rotation, or part rotation (once per rotation equates to 1 ms measurements at a 1 kHz shaft speed), or for a small number of shaft rotations, for example, 5 to 10 rotations which equates to 5 to 10 ms at a 1 kHz shaft speed). Analysis in the frequency domain can allow bearing wear logic to identify components at characteristic bearing fault frequencies. Those frequencies may be predetermined based upon analysis of pumps having bearing wear failure modes, or may comprise identified “new” frequency features compared to a historic frequency analysis of pump operation.

According to one general related approach, bearing wear logic or circuitry provided as part of bearing wear monitoring apparatus 50 may be configured to measure or monitor time taken by the shaft to complete a revolution, or some other fixed angular movement. In other words, the bearing wear monitoring apparatus may analyse a signal 65 received from rotor position measurement device 60. The measurement can be repeated across multiple consecutive angular movements. The bearing wear logic may be configured to compare adjacent measured or monitored times. The comparison of times may allow the logic to identify variation in those monitored times indicative of ‘snagging’ of the bearing due to wear, and the resultant friction, in the bearing components.

An advantage of the two general related approaches described above resides in the fact that the measurement and monitoring occurs at a rate fast enough to be largely insensitive to pump, as opposed to bearing, factors. For example, as described above, for a pump operating at 1 hHz, it would take 10 msec to measure 10 consecutive rotations of the shaft. The duration of each of those 10 consecutive revolutions could be compared and assessed to determine bearing wear. Pump factors, such as changing gas load, thermal effects and back pressure changes are unlikely to cause a fluctuation of shaft rotation time or speed over the course of 10 ms which could be mistaken for fluctuation caused by bearing wear. In other words, the two general related approaches described provide bearing wear logic which is configured to collect and process operational parameters of a rotor very rapidly in order to eliminate variation caused by macro-effects on a vacuum system 10.

According to one general approach according to an embodiment, bearing wear logic may be configured to measure or monitor pump rotational speed, or shaft rotational speed, and identify instances where rate of change of rotational speed exceeds that associated with expected pump conditions. In other words, the bearing wear monitoring apparatus may be configured to identify a deceleration or acceleration rate, determined from a signal such as 65 from rotor position measurement device 60 and process that signal to identify whether the determined rate exceeds that associated with an allowable and/or expected pump condition, for example, the rate associated with an emergency stop.

According to one general approach according to an embodiment, bearing wear logic may be configured to monitor and/or measure pump power, based on an analysis of power supply signals from power supply electronics 35, and to identify conditions when a preselected threshold maximum power is demanded by a pump control unit 40 at an unexpected time, given known pump operation conditions.

The two general approaches described immediately above may also make use of fast acquisition and processing as described in relation to earlier related approaches, or may be performed at a slower measurement and processing rate. In order to distinguish bearing wear variations in rotation, the general approaches performed at a slower rate may require at least some knowledge of an expected range of pump applications in order to be able to identify times at which rotational speed deceleration or acceleration and/or pump power falls outside expected operational limits. In some embodiments the two general approaches performed at the slower rate may be combined, so that both deceleration and power consumed are monitored and used to determine bearing wear. In this regard a sudden deceleration may be indicative of bearing wear but it may also be indicative of a change in pumping conditions. The power consumed immediately or soon after this may provide further information regarding the cause of the deceleration and may be used to in effect confirm or deny the fault diagnosis.

Having described an overview of each of four general approaches, more detail in relation to each approach is provided:

### Phase Current

As described above, some approaches provide bearing wear logic which is configured to monitor and/or measure phase current over very short time periods, for example, 1, 2 or more times per shaft revolution, and then perform a transformation of the monitored phase current into the frequency domain. Transforming the current into the frequency domain allows components at certain frequencies to be resolved and identification of those frequencies typically associated with bearing wear. For example, synchronous frequency could be filtered from the frequency-transformed signal and other frequencies of interest, for example, ball-passing frequencies, bearing cage frequency and similar, can be identified, extracted and monitored. Such values can, for example, be tracked through the life of a pump and compared with a predetermined threshold value or compared with previous values to spot bearing wear or bearing related failures. For example, bearing cage frequency (a sub-synchronous frequency) can be a good indicator of certain failure modes and can be a useful parameter to measure and track over time. It will also, of course, be appreciated, that the phase current is typically a rippling current locked to switching frequency, and that each measurement may itself comprise an indication of an averaged value.

### Shaft Rotation Time

As described above, some approaches provide bearing wear logic which is configured to measure and monitor time to complete a rotation (or half rotation or other fixed angular movement depending on the number of poles in the motor and exact measurement implementation) as a means to monitor bearing wear factors. Rotation time can be monitored and compared with reference values and/or previous values to identify whether localised areas of high friction may be present in the bearing which would suggest signs of wear.

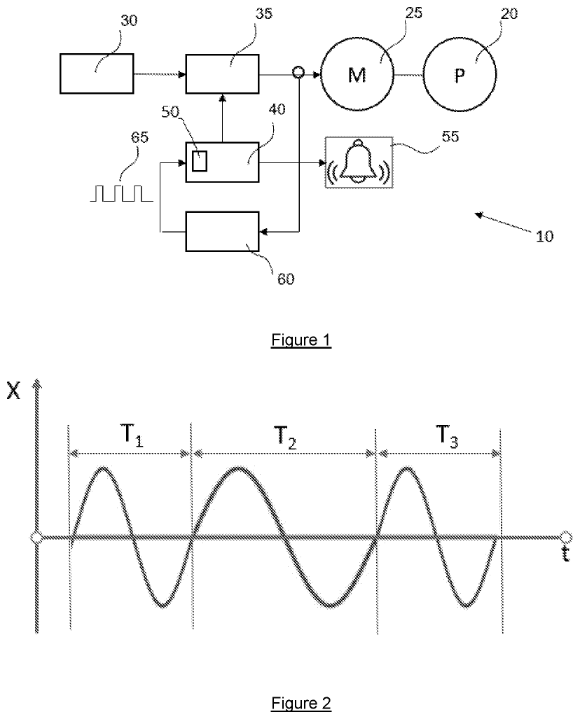

FIG. 2 is a schematic representation of a signal to be monitored by a bearing wear monitoring device such as that shown in FIG. 1. In particular, FIG. 2 illustrates a signal 65 such as one which may be generated by a rotor position measurement device 60. The signal shown is a plot of an estimated value that varies sinusoidally with rotor angle, versus time and variation between adjacent revolutions T₁, T₂, T₃ can be seen. That variation can be analysed by bearing wear monitoring device 50 and inconsistent variation between revolutions due to friction changes, indicative of bearing wear, can be identified.

### Rotor Deceleration

As described above, some approaches according to an embodiment provide bearing wear logic which is configured to measure and monitor rotor or pump deceleration rate. If the logic determines that the measured rotor deceleration rate falls outside expected values it may be configured to alert a user, triggers an alarm, or adjust pump rotor operational parameters. For example, different deceleration rates can be established for each pump type in relation to expected operational events, for example: controlled braking, gas venting, gas loads and similar. A predetermined understanding and knowledge of such events can help provide an indication of usual operational deceleration and can help in the selection of an appropriate maximum expected deceleration rate. Once a deceleration threshold has been selected, bearing wear logic may be configured to continuously monitor rotational speed of a pump and, if the deceleration rate exceeds the maximum expected threshold value, trigger identification of a likely fault condition. In some embodiments rather than immediately triggering identification of a likely fault condition detection of the deceleration may rather trigger the monitoring of power consumed and only if this exceeds a threshold value will the fault condition be identified. In either case once the likely fault condition has been identified an alarm or other similar signal may, in some cases, be triggered to alert a pump user of the fault condition. In some implementations, the bearing wear logic, in combination with pump control logic, may be configured such that a pump may be tripped into a safe fail mode, and operation of the pump stopped. Stopping a pump in a controlled manner without intervention can be advantageous in the case of unattended pumps.

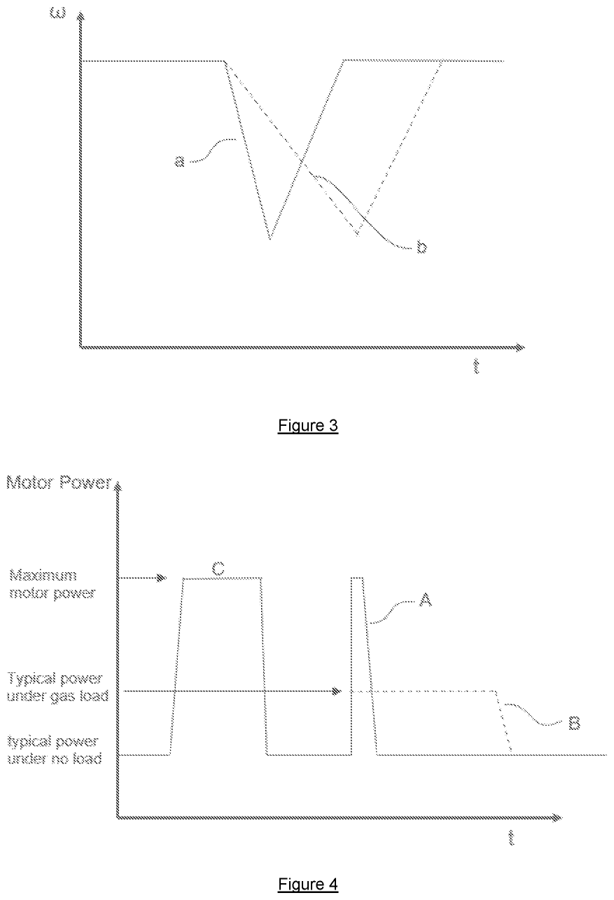

FIG. 3 is a schematic representation of an alternative signal to be monitored by a bearing wear monitoring device such as that shown in FIG. 1. In particular, FIG. 3 shows a signal which may result from monitoring rotational speed of a pump or motor shaft over time. Normal operation of a pump is such that a substantially fixed target rotational speed is maintained. The dashed line (b) illustrates deceleration of a motor shaft, or of the pump, due to expected operational condition, and the solid line (a) illustrates deceleration as might be expected from a bearing fault. The rate of any rotational speed change can be analysed by bearing wear monitoring device 50 and a rate of deceleration which exceeds a selected threshold value, indicative of bearing wear or bearing faults, can be identified.

### Motor Power Demand

As described above, some approaches provide bearing wear logic which is configured to measure and monitor motor power. The bearing wear logic may be configured such that if the power exceeds the maximum expected threshold value, or reaches maximum power, the logic identifies a likely fault condition and triggers an alarm. The bearing wear logic may be configured to monitor additional pump control parameters, to aid identification of a case in which a maximum power request is indicative of a bearing wear issue. In particular, for example, the logic may be configured to ignore, or prevent triggering of an alarm condition, during pump ramp or pump start up where maximum power will be delivered in order to accelerate the pump to full speed. According to some examples, bearing wear logic implementing a motor power demand monitoring regime may link such a regime with monitoring or evaluation of one or more additional pump parameter, for example, rotational speed, deceleration or time since START command received. The motor power demand bearing wear approach may be active if a combination of thresholds or trigger conditions associated with one or more signals are satisfied. Approaches employing bearing wear monitoring of motor power can have particular use in relation to pump applications where gas load is well known and load on the pump due to gas load is below the maximum set in the drive.

FIG. 4 is a schematic representation of a further signal to be monitored by a bearing wear monitoring device such as that shown in FIG. 1. In particular, FIG. 4 illustrates a plot of monitored motor power over time. If the pump is not exposed to a significant gas load, the motor power will typically be substantially constant. Similarly, if the pump is exposed to an increased, but constant, gas load, motor power will be increased, but also substantially constant. A rapid change of gas load, or on initial start up, may be such that maximum motor power is developed and held for a period of time, as shown as peak C in FIG. 4. Otherwise, determining that the motor is running at maximum power, in a manner not triggered by an expected change in pump condition, may be indicative of a pump fault. Such a fault condition is illustrated as peak A in FIG. 4. Instances of peak or maximum motor power can be analysed by bearing wear monitoring device 50 and unexpected periods at maximum power, indicative, for example, of bearing wear, can be identified.

It will be appreciated that whilst described separately, the bearing wear monitoring approaches described above may be used in combination. In particular, an alarm or system shutdown may be triggered if bearing wear is determined according to one described approach, but may advantageously be triggered in the event that two or more threshold conditions, each depending on different monitored rotor operation parameters, indicative of likely bearing wear are met.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Various related embodiments and/or examples are set out in the following numbered paragraphs.

A bearing wear monitoring apparatus configured to monitor bearings of a vacuum pump having an electric motor comprising a rotating assembly, the monitoring apparatus comprising:
input reception circuitry configured to receive a signal indicative of a characteristic of rotating assembly rotation; and
bearing wear monitoring circuitry configured to analyse the signal characteristic of rotating assembly rotation and identify one or more signal feature indicative of bearing wear.

A bearing wear monitoring apparatus according to numbered paragraph [0090], wherein the signal feature is predefined and represents a known bearing wear condition.

A bearing wear monitoring apparatus according to numbered paragraph or numbered paragraph [0091], comprising: a user alarm configured to be triggered on identification of the one or more signal feature indicative of bearing wear.

A bearing wear monitoring apparatus according to any preceding numbered paragraph, wherein the signal indicative of a characteristic of rotating assembly rotation comprises an indication of rotation period, and wherein the bearing wear monitoring circuitry is configured to analyse consecutive rotation periods to identify the one or more signal feature indicative of bearing wear.

A bearing wear monitoring apparatus according to numbered paragraph [0093], wherein the rotation period comprises a time to complete a known angular rotation.

A bearing wear monitoring apparatus according to numbered paragraph or numbered paragraph [0094], wherein the signal feature indicative of bearing wear comprises: variability in the rotation period exceeding a predetermined threshold.

A bearing wear monitoring apparatus according to any one of numbered paragraphs to [0095], wherein the signal feature indicative of bearing wear comprises: identification of increased variability on the rotation period compared to historic variation in the rotation period.

A bearing wear monitoring apparatus according to any preceding numbered paragraph, wherein the signal indicative of a characteristic of rotating assembly rotation comprises: an indication of rotational speed, and wherein the bearing wear monitoring circuitry is configured to analyse rotational speed over time to identify the one or more signal feature indicative of bearing wear.

A bearing wear monitoring apparatus according to numbered paragraph [0097], wherein the signal feature indicative of bearing wear comprises: rate of deceleration exceeding a predetermined threshold.

A bearing wear monitoring apparatus according to numbered paragraph or numbered paragraph [0098], wherein the signal feature indicative of bearing wear comprises: identification of increased deceleration compared to historic deceleration events.

A bearing wear monitoring apparatus according to any preceding numbered paragraph, wherein the signal indicative of a characteristic of rotating assembly rotation comprises: an indication of motor power, and wherein the bearing wear monitoring circuitry is configured to analyse motor power over time to identify the one or more signal feature indicative of bearing wear.

A bearing wear monitoring apparatus according to numbered paragraph [0100], wherein the signal feature indicative of bearing wear comprises: motor power being at a maximum for a predetermined time period.

A bearing wear monitoring apparatus according to numbered paragraph or numbered paragraph [0101], wherein the input reception circuitry is configured to receive a signal indicative of an operational characteristic of the vacuum pump, and the signal feature indicative of bearing wear comprises: motor power being at a maximum despite the operational characteristic signal indicating that the vacuum pump is unlikely to require maximum motor power.

A bearing wear monitoring apparatus according to any preceding numbered paragraph, wherein the signal indicative of a characteristic of rotating assembly rotation comprises an indication of variation of motor phase current over time, and wherein the bearing wear monitoring circuitry is configured to transform the time-based signal into a frequency-based signal; and analyse the frequency-based signal to identify the one or more signal feature indicative of bearing wear.

A bearing wear monitoring apparatus according to numbered paragraph [0103], wherein the signal feature indicative of bearing wear comprises: at least one signal peak occurring at a predefined frequency or in a predefined frequency range in the frequency-based signal.

A bearing wear monitoring apparatus according to numbered paragraph or numbered paragraph [0104], wherein the signal feature indicative of bearing wear comprises: a signal peak passing a predefined threshold amplitude in the frequency-based signal.

A bearing wear monitoring apparatus according to any one of numbered paragraphs to [0105], wherein the signal feature indicative of bearing wear comprises: identification of at least one new signal peak in the frequency-based signal compared to historic patterns in the frequency-based signal.

A bearing wear monitoring apparatus according to any preceding numbered paragraph, wherein a bearing wear fault diagnostic is associated with the identification of the one or more signal feature indicative of bearing wear.

A vacuum pump apparatus comprising a bearing wear monitoring apparatus as numbered paragraphed in any one of numbered paragraphs to [0107].

A method of monitoring wear of bearings of a vacuum pump having an electric motor comprising a rotating assembly, the method comprising: receiving a signal indicative of a characteristic of rotating assembly rotation; and analysing the signal characteristic of rotating assembly rotation to identify one or more signal feature indicative of bearing wear.

A computer program comprising computer readable instructions which, when executed by a processor, are configured to cause a device to perform a method according to numbered paragraph [0109].

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A bearing wear monitoring apparatus configured to monitor bearings of a vacuum pump having an electric motor comprising a rotating assembly, the monitoring apparatus comprising:
input reception circuitry configured to receive a signal indicative of a characteristic of rotating assembly rotation, the signal indicative of a characteristic of rotating assembly rotation comprising both of an indication of rotational speed, and an indication of motor power; and
bearing wear monitoring circuitry configured to analyze the signal characteristic of rotating assembly rotation over time to identify one or more signal feature indicative of bearing wear.

2. The bearing wear monitoring apparatus according to claim 1, wherein the signal feature is predefined and represents a known bearing wear condition.

3. The bearing wear monitoring apparatus according to claim 1, comprising: a user alarm configured to be triggered on identification of the one or more signal feature indicative of bearing wear.

4. The bearing wear monitoring apparatus according to claim 1, wherein the signal feature indicative of bearing wear comprises: rate of deceleration exceeding a predetermined threshold.

5. The bearing wear monitoring apparatus according to claim 1, wherein the signal feature indicative of bearing wear comprises: identification of increased deceleration compared to historic deceleration events.

6. The bearing wear monitoring apparatus according to claim 1, wherein the signal feature indicative of bearing wear comprises: motor power being at a maximum for a predetermined time period.

7. The bearing wear monitoring apparatus according to claim 1, wherein the input reception circuitry is configured to receive a signal indicative of an operational characteristic of the vacuum pump, and the signal feature indicative of bearing wear comprises: motor power being at a maximum despite the operational characteristic signal indicating that the vacuum pump is unlikely to require maximum motor power.

8. (canceled)

9. The bearing wear monitoring apparatus according to claim 1, wherein a bearing wear fault diagnostic is associated with the identification of the one or more signal feature indicative of bearing wear.

10. The bearing wear monitoring apparatus according to claim 9, the bearing wear monitoring apparatus being responsive to determining that the rate of deceleration exceeds the predetermined threshold to monitor power during a time period following said detected deceleration, the bearing wear fault diagnostic being responsive to an indication that said motor power monitored during said time period has exceeded a predetermined threshold to indicate bearing wear.

11. A vacuum pump apparatus comprising a bearing wear monitoring apparatus as claimed in claim 1.

12. A method of monitoring wear of bearings of a vacuum pump having an electric motor comprising a rotating assembly, the method comprising:
receiving a signal indicative of a characteristic of rotating assembly rotation the signal indicative of a characteristic of rotating assembly rotation comprising both of an indication of rotational speed, and an indication of motor power; and
analyzing the signal characteristic of rotating assembly rotation over time to identify one or more signal feature indicative of bearing wear.

13. A computer program comprising computer readable instructions which, when executed by a processor, are configured to cause a device to perform a method according to claim 12.

14. The method according to claim 12, further comprising in response to determining that a rate of deceleration exceeds a predetermined threshold, monitoring power during a time period following said detected deceleration, and in response to an indication that said motor power monitored during said time period has exceeded a predetermined threshold, generating a bearing wear fault diagnostic indicating bearing wear.
